(19) United States
(12) Patent Application Publication
(10) Pub. No.: US 2026/0162027 A1
(43) Pub. Date: Jun. 11, 2026

(54) TRAVELING ROUTE GENERATION APPARATUS, TRAVELING ROUTE GENERATION METHOD AND PROGRAM

(71) Applicant: NTT, Inc., Tokyo (JP)

(72) Inventors: Yusuke NAKANO, Tokyo (JP); Zhao WANG, Tokyo (JP)

(21) Appl. No.: 19/124,032

(22) PCT Filed: Oct. 28, 2022
(86) PCT No.: PCT/JP2022/040354

§ 371 Date: Apr. 24, 2025

(51) Int. Cl. G06Q 10/047; G06Q 10/0631

(52) U.S. Cl. CPC G06Q 10/047; G06Q 10/06315

(57) ABSTRACT

A tour route generation apparatus according to an aspect of the present disclosure is a tour route generation apparatus for generating a tour route of a moving body having demand places where resources supplied by the moving body are demanded and supply places where the resources are supplied to the moving body as visit destinations, the tour route generation apparatus including: a training data generation unit configured to generate training data for training a model for generating the tour route by using generation conditions including conditions for generating information on the demand places and conditions for generating information on the supply places; and a model training unit configured to learn a policy represented by the model through reinforcement learning using the training data.

### TECHNICAL FIELD

The present disclosure relates to a tour route generation apparatus, a tour route generation method, and a program.

### BACKGROUND ART

A vehicle routing problem (VRP) is an optimization problem for obtaining an optimal tour route among routes for touring all visit destinations by using one or more vehicles under various constraints.

There are various variations among VRPs, including, for example, a VRP with a time window (VRPTW), a VRP with a capacity restriction (CVRP), and the like. A VRPTW is an optimization problem for obtaining an optimum tour route while satisfying a time window for a visit destination in a situation in which the time window is set. Further, a CVRP is an optimization problem for obtaining an optimum tour route while satisfying a demand of a visit destination within the range of a maximum loading amount in a situation in which a fixed maximum loading amount is set for a vehicle and a demand amount is set for the visit destination.

Although various solutions for a VRP and variations thereof have been proposed, a method of solving a VRP using reinforcement learning has been proposed in recent years. For example, NPL 1 proposes a method of solving a VRPTW using reinforcement learning. Further, for example, NPL 2 proposes a method of solving a CVRP using reinforcement learning.

Here, for example, in cases such as a case where system power cannot be used due to occurrence of a disaster or the like, it is assumed that a vehicle (power supply vehicle) on which a generator or the like is mounted is caused to travel with buildings and the like at power supply places as visit destinations. At this time, it is also assumed that buildings and the like at power supply places are visited while supplying fuel to the generator. That is, it is also assumed that, when the fuel of the generator runs out, buildings and the like at power supply places are visited while supplying the fuel to the generator at refuel places such as gas stations without returning to a departure point. For this reason, it is necessary to obtain a tour route on which refuel places and power supply places are present together in consideration of the remaining fuel of the generator.

### CITATION LIST

### Non Patent Literature

NPL 1: Q. Ma, S. Ge, D. He, D. Thaker, and I. Drori. Combinatorial optimization by graph pointer networks and hierarchical reinforcement learning. In AAAI Workshop on Deep Learning on Graphs: Methodologies and Applications, AAAI, 2020.
NPL 2: M. Nazari, A. Oroojlooy, L. Snyder, and M. Takac. Reinforcement learning for solving the vehicle routing problem. In Proceedings of the 32nd Conference on Advances in Neural Information Processing Systems, NeurIPS, pages 9839-9849, 2018.

### SUMMARY OF INVENTION

### Technical Problem

However, conventionally, a tour route having only a building or the like at a power supply place as a visit destination is obtained, and a tour route having a refuel place as a visit destination cannot be obtained. That is, more generally, conventionally, it is impossible to obtain a tour route having demand places where objects and energy supplied by a vehicle are demanded and a supply place where objects and energy are supplied to the vehicle as visit destinations.

The present disclosure has been made in consideration of the above, and an object of the present disclosure is to provide a technique through which a tour route having demand places and supply places as visit destinations can be generated.

### Solution to Problem

A tour route generation apparatus according to an aspect of the present disclosure is a tour route generation apparatus for generating a tour route of a moving body having demand places where resources supplied by the moving body are demanded and supply places where the resources are supplied to the moving body as visit destinations, the tour route generation apparatus including: a training data generation unit configured to generate training data for training a model for generating the tour route by using generation conditions including conditions for generating information on the demand places and conditions for generating information on the supply places; and a model training unit configured to learn a policy represented by the model through reinforcement learning using the training data.

### Advantageous Effects of Invention

A technique through which a tour route having demand places and supply places as visit destinations can be generated is provided.

### BRIEF DESCRIPTION OF DRAWINGS

FIG. 1 is a diagram showing an example of a hardware configuration of a tour route generation apparatus according to the present embodiment.

FIG. 2 is a diagram showing an example of a functional configuration of the tour route generation apparatus according to the present embodiment.

FIG. 3 is a flowchart showing an example of model training processing according to the present embodiment.

FIG. 4 is a diagram schematically showing an example of training data generation.

FIG. 5 is a diagram schematically showing an example of model training.

FIG. 6 is a flowchart showing an example of tour route generation processing according to the present embodiment.

FIG. 7 is a diagram schematically showing an example of tour route generation.

### DESCRIPTION OF EMBODIMENTS

An embodiment of the present invention will be described below. In the following embodiment, a tour route generation apparatus 10 for generating an optimum tour route having power supply places (demand places) where a storage battery for which power is demanded is installed and refuel places (supply places) where fuel is supplied to a generator as visit destinations, assuming a vehicle (power supply vehicle) on which the generator is mounted, will be described. Here, as the power supply places, for example, a building, a factory, various facilities, and the like where the storage battery is installed are conceivable. Particularly, as the power supply places, for example, a building, a factory, various facilities, and the like where a storage battery is installed within an area where power is interrupted at the time of disaster occurrence are conceivable. Further, as the refuel places, for example, gas stations and the like are conceivable. Although one storage battery is installed at one power supply place for simplicity in the following description, the present embodiment can be similarly applied when a plurality of storage batteries are installed at one power supply place by collectively regarding the plurality of storage batteries as one storage battery.

Assuming that there is a power supply vehicle and that visit destinations are demand places where power is demanded and supply places where fuel is supplied to a generator is an example and the present disclosure is not limited thereto. The present disclosure is also similarly applicable to the following cases.
A case in which a vehicle capable of loading propane gas is assumed, and an optimal tour route having buildings (demand places) where propane gas is demanded and business places (supply places) where propane gas capable of being loaded on the vehicle is installed as visit destinations is generated
A case in which a vehicle capable of loading a beverage or the like is assumed, and an optimal tour route having automatic vending machines (demand places) in which the beverage or the like is replenished and business places (supply places) where the beverage or the like capable of being loaded on the vehicle is present as visit destinations is generated
A case in which an electric vehicle (EV) is assumed, and an optimal tour route having an evacuation place and the like (demand places) where power is demanded in the case of a disaster and charging places (supply places) of the EV as visit destinations is generated
A case in which a vehicle capable of loading waste and the like is assumed, and an optimum tour route having a waste disposal center (demand place) where waste or the like is discarded and an accumulation place (supply place) where waste or the like loaded on the vehicle is present as visit destinations is generated

However, the aforementioned cases are examples and the present disclosure is not limited thereto. Further, although vehicles are assumed in the aforementioned cases, a moving body touring visit destinations is not limited to the vehicles. Examples of a moving body may include a person, a drone, a ship, a bicycle, a motorcycle, an airplane, a spacecraft, and the like in addition to vehicles.

### <Overview of Tour Route Generation>

In the present embodiment, a tour route is generated by reinforcement learning under the following conditions. An existing method (for example, the reinforcement learning methods described in NPL 1, NPL 2, and the like) is used as a method of reinforcement learning.

A power supply vehicle has an amount of power that can be supplied. Further, a maximum value of the amount of power that can be supplied is predetermined in the power supply vehicle.
When the power supply vehicle arrives at a power supply place, the amount of power that can be supplied from the power supply vehicle decreases in accordance with the amount of remaining power of a storage battery installed at the power supply place, and the amount of remaining power of the storage battery increases according to the decrease. For example, the amount of power that can be supplied from the power supply vehicle is reduced by a value obtained by subtracting the amount of remaining power from the maximum capacity of the storage battery, the amount of remaining power is increased by the amount of reduction, and the amount of remaining power of the storage battery is set to the maximum capacity. However, the amount of power that can be supplied from the power supply vehicle is equal to or greater than 0, and is not negative.
When the power supply vehicle arrives at a refuel place, the amount of power that can be supplied from the power supply vehicle reaches the maximum value.

At the time of the aforementioned reinforcement learning, data including the following information is generated as training data, and a policy for tour route generation is learned using the training data.
Random locations of power supply places close to an actual geographical distribution of power supply places
Random locations of refuel places close to an actual geographical distribution of refuel places
A random amount of remaining power of a storage battery installed at a power supply place
A random power consumption rate of a storage battery installed at a power supply place
A random maximum capacity of a storage battery installed at a power supply place
An initial value of the actual amount of power that can be supplied from a power supply vehicle
Random initial locations of power supply vehicles with respect to the actual number of power supply vehicles

Here, a power consumption rate is the amount of power consumed (discharged) by a storage battery in a predetermined unit time. It is assumed that the geographical ranges of the locations of power supply places and refuel places (that is, an upper limit value and a lower limit value of latitudes, and an upper limit value and a lower limit value of longitudes) are predetermined.

### <Example of Hardware Configuration of Tour Route Generation Apparatus 10>

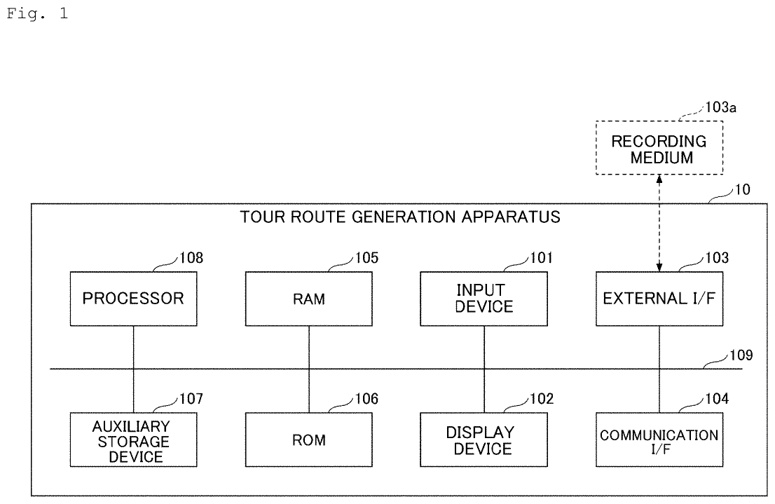

FIG. 1 shows an example of a hardware configuration of a tour route generation apparatus 10 according to the present embodiment. As shown in FIG. 1, the tour route generation apparatus 10 according to the present embodiment includes an input device 101, a display device 102, an external I/F 103, a communication I/F 104, a random access memory (RAM) 105, a read only memory (ROM) 106, an auxiliary storage device 107, and a processor 108. These pieces of hardware are connected such that they can communicate via a bus 109.

The input device 101 is, for example, a keyboard, a mouse, a touch panel, or physical buttons, or the like. The display device 102 is, for example, a display, a display panel, or the like. The tour route generation apparatus 10 may not have at least one of the input device 101 and the display device 102.

The external I/F 103 is an interface with an external device such as a recording medium 103a. The tour route generation apparatus 10 can perform reading, writing, and the like on the recording medium 103a via the external I/F 103. Examples of the recording medium 103a include a flexible disk, a compact disc (CD), a digital versatile disk (DVD), a secure digital (SD) memory card, a Universal Serial Bus (USB) memory card, and the like.

The communication I/F 104 is an interface for connecting the tour route generation apparatus 10 to a communication network. The RAM 105 is a volatile semiconductor memory (storage device) that temporarily retains a program and data. The ROM 106 is a nonvolatile semiconductor memory (storage device) that can retain a program and data even when the power is turned off. The auxiliary storage device 107 is, for example, a storage device such as a hard disk drive (HDD), a solid state drive (SSD), or a flash memory. The processor 108 is, for example, an arithmetic device such as a central processing unit (CPU) or a graphics processing unit (GPU).

The tour route generation apparatus 10 according to the present embodiment can realize model training processing and tour route generation processing which will be described later by having the hardware configuration shown in FIG. 1. The hardware configuration shown in FIG. 1 is merely an example, and the hardware configuration of the tour route generation apparatus 10 is not limited thereto. For example, the tour route generation apparatus 10 may include a plurality of auxiliary storage devices 107 and a plurality of processors 108, may not have some of the illustrated hardware, or may include various types of hardware other than the illustrated hardware.

### <Example of Functional Configuration of Tour Route Generation Apparatus 10>

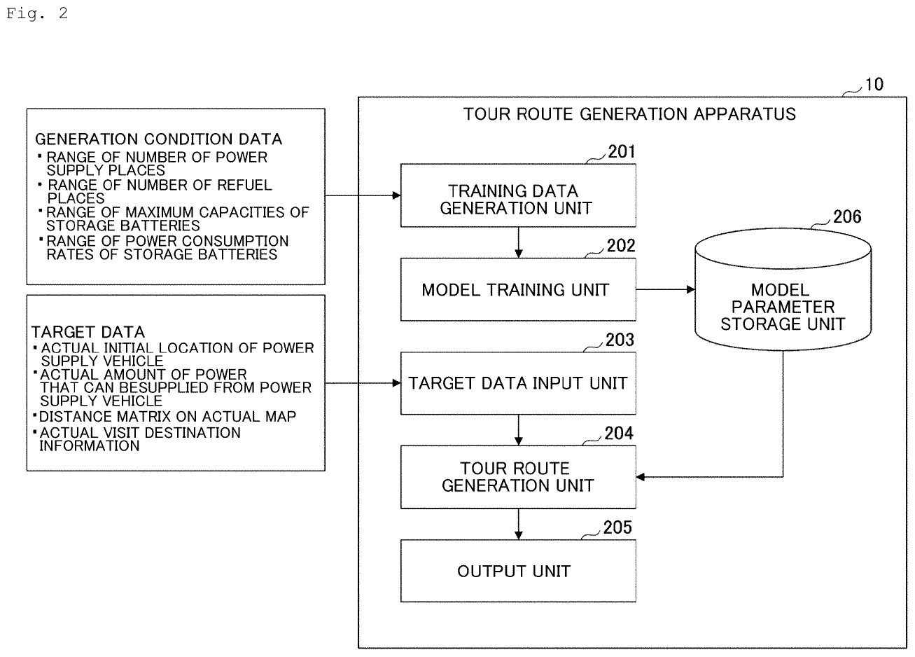

FIG. 2 shows an example of a functional configuration of the tour route generation apparatus 10 according to the present embodiment. As shown in FIG. 2, the tour route generation apparatus 10 according to the present embodiment includes a training data generation unit 201, a model training unit 202, a target data input unit 203, a tour route generation unit 204, and an output unit 205. Each of these functional units is realized by one or more programs installed in the tour route generation apparatus 10 causing the processor 108 to execute processing. Further, the tour route generation apparatus 10 according to the present embodiment includes a model parameter storage unit 206. The model parameter storage unit 206 is realized by, for example, the auxiliary storage device 107. However, the model parameter storage unit 206 may be realized by, for example, a storage device such as a database server connected to the tour route generation apparatus 10 via a communication network.

The training data generation unit 201 generates a plurality of pieces of training data satisfying conditions for generating training data when data representing the conditions (hereinafter referred to as generation condition data) is provided. The generation condition data includes, for example, information representing the following conditions.
The range of the number of power supply places
The range of the number of refuel places
The range of maximum capacities of storage batteries installed at power supply places
The range of power consumption rates of storage batteries installed at power supply places

In other words, the generation condition data include an upper limit value and a lower limit value of the number of power supply places, an upper limit value and a lower limit value of the number of refuel places, an upper limit value and a lower limit value of maximum capacity of each storage battery, and an upper limit value and a lower limit value of the power consumption rate of each storage battery. The generation condition data may be provided via the input device 101 or the like included in the tour route generation apparatus 10, or may be provided from a server, a terminal or the like connected to the tour route generation apparatus 10 via a communication network.

Here, the training data includes initial locations of the actual number of power supply vehicles, an initial value of the actual amount of power that can be supplied from each of the power supply vehicles, visit destination information representing various types of information of visit destinations (the locations of the visit destinations, whether a visit destination is a power supply place or a refuel place, and when the visit destination is a refuel place, the maximum capacity, the amount of remaining power, and power consumption rate of a storage battery), and a distance matrix representing the distance between nodes when the initial locations of the power supply vehicles and the respective visit destinations are regarded as nodes of a graph.

The model training unit 202 learns parameters (hereinafter referred to as model parameters) of a model representing a policy for tour route generation using a plurality of pieces of training data generated by the training data generation unit 201 through reinforcement learning. Further, the model training unit 202 stores the learned model parameters in the model parameter storage unit 206.

The target data input unit 203 receives data (hereinafter referred to as target data) including initial locations of the actual number of power supply vehicles, an initial value of the actual amount of power that can be supplied from each of the power supply vehicles, a distance matrix representing distances on a map (travel distances on the map) when the actual initial locations of the power supply vehicles and the respective visit destinations are regarded as nodes of a graph, and visit destination information representing various types of information of such visit destinations. The target data may be provided via the input device 101 or the like included in the tour route generation apparatus 10, or may be provided from a server, a terminal or the like connected to the tour route generation apparatus 10 via a communication network.

The tour route generation unit 204 generates a tour route according to a policy represented by the model to which the learned model parameters stored in the model parameter storage unit 206 have been set using the target data input through the target data input unit 203.

The output unit 205 outputs the tour route generated by the tour route generation unit 204 to a predetermined output destination. Here, as the predetermined output destination, for example, the auxiliary storage device 107, the display device 102, or a server, a terminal, or the like connected to the tour route generation apparatus 10 via a communication network is conceivable.

When outputting the tour route to the display device 102 or a terminal or the like connected to the tour route generation apparatus 10 via a communication network, the output unit 205 may output map information corresponding to a geographical range including the tour route along with the tour route. Accordingly, information obtained by superimposing the tour route on the map can be displayed on the display device 102, the terminal, or the like. The database or the like in which the map information is stored may be included in the tour route generation apparatus 10, or may be included in a database server or the like connected to the tour route generation apparatus 10 via a communication network.

The model parameter storage unit 206 stores the learned model parameters learned by the model training unit 202. The model parameter storage unit 206 may store model parameters before learning and model parameters during learning.

Although one tour route generation apparatus 10 has all the functional units and storage units in the example shown in FIG. 2, these functional units and storage units may be included in a plurality of devices in a distributed manner. In addition, some functional units may be realized by a cloud service or the like.

For example, the training data generation unit 201, the model training unit 202, and the model parameter storage unit 206 may be included in a certain device (which may be referred to as a training device) and the target data input unit 203, the tour route generation unit 204, and the output unit 205 may be included in a different device (which may be referred to as a tour route generation apparatus).

### <Model Training Processing>

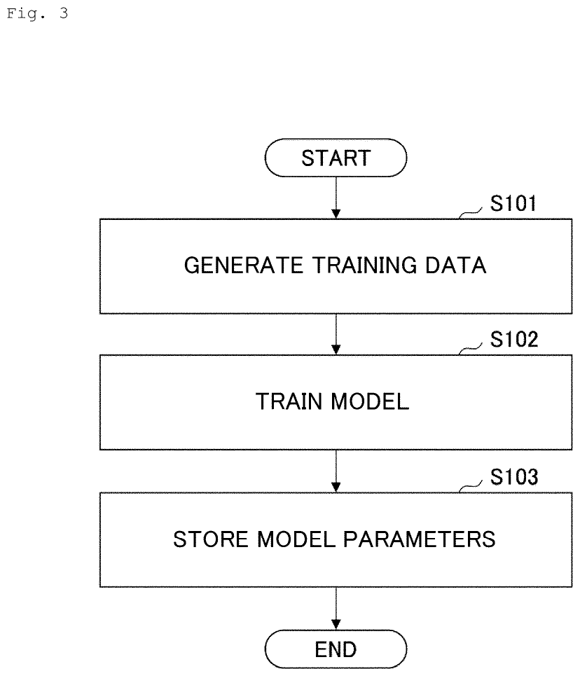

Hereinafter, model training processing according to the present embodiment will be described with reference to FIG. 3.

First, the training data generation unit 201 generates a plurality of pieces of training data satisfying conditions represented by provided generation condition data using the generation condition data (step S101). Hereinafter, the range of the number of power supply places is defined as [N₁, N₂], the range of the number of refuel places is defined as [M₁, M₂], the range of maximum capacities of storage batteries installed in the power supply places is defined as [C₁, C₂], and the range of power consumption rates of the storage batteries installed in the power supply places is defined as [E₁, E₂]. N₁, N₂, M₁, M₂, E₁, and E₂ are preset parameters.

At this time, the training data generation unit 201 generates training data by, for example, the following procedures 1 to 7.

Procedure 1: The training data generation unit 201 randomly samples an initial location sᵢ=(xᵢ, yᵢ)∈X×Y of a power supply vehicle i for i∈{0, . . . , K−1}. Here, K is the actual number of power supply vehicles. Further, X×Y represents a predetermined geographical range, X represents a longitude range, and Y represents a latitude range. In the following, it is assumed that K=1 for simplicity. The following description can be easily extended even when K≥2.

Procedure 2: The training data generation unit 201 randomly samples the number of power supply places n∈(N₁, N₂). However, n is an integer of 1 or more. Hereinafter, it is assumed that the number for identifying each power supply place is i∈{1, . . . , n}.

Procedure 3: The training data generation unit 201 randomly samples the number of refuel places m∈[M₁, M₂]. Here, m is an integer of 1 or more. Hereinafter, it is assumed that the number for identifying each refuel place is i∈{n+1, . . . , n+m}.

Procedure 4: The training data generation unit 201 randomly samples a location sᵢ=(xᵢ, yᵢ)∈X×Y of a visit destination i representing either a power supply place or a refuel place for i∈{1, . . . n, n+1, . . . , n+m}.

Procedure 5: The training data generation unit 201 randomly samples the maximum capacity cᵢ∈[C₁, C₂], the amount of remaining power rᵢ∈[0, cᵢ], and a power consumption rate e₁∈[E₁, E₂] of a storage battery installed in the visit destination i representing a power supply place for i∈{1, . . . , n}.

Procedure 6: The training data generation unit 201 calculates a distance Δᵢⱼ between i and j representing a power supply vehicle at an initial location and a power supply place or a refuel place for i∈{0, 1, . . . , n, n+1, . . . , n+m} and j∈{0, n, n+1, . . . , n+m}, and creates, as a distance matrix, a matrix Δ=(Δⱼᵢ) of (n+m+1) rows and (n+m+1) columns having the distance Δᵢⱼ as elements (i, j). Here, the distance Δᵢⱼ may be calculated by, for example, Δᵢⱼ=d(sᵢ, sⱼ) using a predetermined distance function d. Although various functions for measuring a distance can be used as the distance function d, a function for measuring the Euclidean distance can be typically used.

However, the aforementioned method of calculating Δᵢⱼ is an example and the present disclosure is not limited thereto. For example, calculation of Δᵢⱼ=0 when i=j and Δᵢⱼ=γ×d(sᵢ, sⱼ)+ε when i≠j may be performed using a predetermined coefficient 0<γ≤1 and a minute value ε representing noise.

Although the distance Δᵢⱼ has been calculated in the above description, time (travel time) may be calculated instead of the distance.

Procedure 7: Then, the training data generation unit 201 sets D=({(sᵢ, cᵢ, rᵢ, eᵢ)|i=1, . . . , n}, {sᵢ|i=n+1, . . . , n+m}, Δ, s₀, r₀) as training data. Here, r₀ is an initial value of the actual amount of power that can be supplied from a power supply vehicle i=0. {(sᵢ, cᵢ, rᵢ, eᵢ)|i=1, . . . , n} represents visit destination information of power supply places, {sᵢ|i=n+1, . . . , n+m} represents visit destination information of refuel places, Δ represents a distance matrix, and s₀ and r₀ represent an actual initial location of a power supply vehicle and an initial value of the actual amount of power that can be supplied from the power supply vehicle.

By repeatedly executing the above procedures 1 to 7 a plurality of times, a plurality of pieces of training data are generated. For example, if the number of generations of training data is L, the procedures 1 to 7 are repeatedly executed L times to generate L pieces of training data.

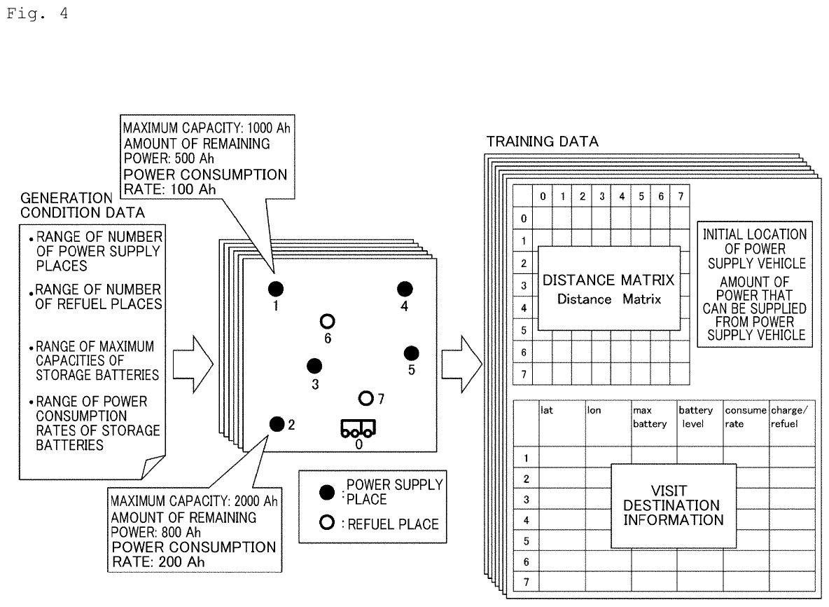

As an example, FIG. 4 schematically shows generation of training data when K=1. The example shown in FIG. 4 shows a case in which n=5 and m=2. In visit destination information in FIG. 4, “lat” represents latitude, “lon” represents longitude, “max battery” represents maximum capacity, “battery level” represents the amount of remaining power, “consume rate” represents a power consumption rate, and “charge/refuel” represents either a power supply place or a refuel place. When “charge/refuel” indicates a refuel place, values are not set to “max battery,” “battery level,” and “consume rate” (or empty values or the like are set).

Next, the model training unit 202 learns model parameters of a model representing a policy for tour route generation through reinforcement learning using the plurality of pieces of training data generated in step S101 (step S102). For example, the model training unit 202 may learn the model parameters through the Actor-Critic reinforcement learning as in NPL 1, NPL 2, and the like. More specifically, the model training unit 202 calculates a conditional probability of a next visit destination using a neural network (pointer network) composed of an encoder and a decoder as an actor network, and calculates a reward by a critic network as in NPL 1, NPL 2, and the like, for example. Then, the model training unit 202 learns parameters of the actor network and the critic network such that the reward is maximized using a policy gradient method or the like. The pointer network corresponds to a model representing a policy for tour route generation, and parameters that can be learned by the pointer network corresponds to model parameters.

Here, the encoder of the pointer network includes an embedded layer and a graph convolution layer, and the decoder includes an RNN cell (for example, LSTM or the like) and an attention mechanism. At this time, the coordinates aₜ₋₁=sᵢ and the distance Δᵢⱼ of a visit destination determined at the (t−1)-th step are input to the embedded layer, and embedded in a node feature amount uᵢ and an edge feature amount vᵢⱼ, respectively. It is assumed that a₀=s₀ when t=0. The distance matrix Δ included in the training data and visit destination information {sᵢ, cᵢ, rᵢ, eᵢ)|i=1, . . . , n} and {sᵢ|i=n+1, . . . , n+m} are input to the graph convolution layer as graph data, and the node feature amount uᵢ and the edge feature amount vᵢⱼ are convoluted into a node feature amount uᵢ′ and an edge feature amount vᵢⱼ′ according to graph convolution. The graph convolution layer is realized by, for example, a graph convolutional network (GCN). Thereafter, in the decoder, a conditional probability of the next visit destination is calculated from the node feature amount uᵢ′ and the edge feature amount vᵢⱼ′ by the attention mechanism and the RNN cell. Accordingly, the coordinates aₜ of the next visit destination are sampled from this conditional probability.

By repeating the above operations, a tour route {a₀, a₁, . . . , a_{T}} (T=n+m) is generated. The present disclosure differs from NPL 1, NPL 2, and the like in that the distance matrix Δ and the visit destination information {(sᵢ, cᵢ, rᵢ, eᵢ)|i=1, . . . , n} and {sᵢ|i=n+1, . . . , n+m} are input to the graph convolution layer as graph data, and feature amounts of nodes and edges of the graph are extracted. The other points are the same as those of the reinforcement learning methods described in NPL 1, NPL 2, and the like.

Further, although various rewards may be considered, as an example, the following reward may be considered as a reward R.

$$R = α \times travel distance score + ( 1 - α ) \times storage battery depletion {score}^{}$$

Here, α is a hyper parameter indicating which of the travel distance score and the storage battery depletion score is to be regarded as important, and 0≤α≤1 is taken. Further, the travel distance score is a score which takes a lower value as the travel distance of a power supply vehicle increases, and the storage battery depletion score is a score which takes a lower value as the number of storage batteries whose amounts of remaining power have become less than a predetermined threshold value increases.

That is, the reward R is a reward used when the distance of a tour route is shortened as much as possible and depletion of a storage battery is reduced as much as possible. Other than this, various rewards can be used according to the purpose.

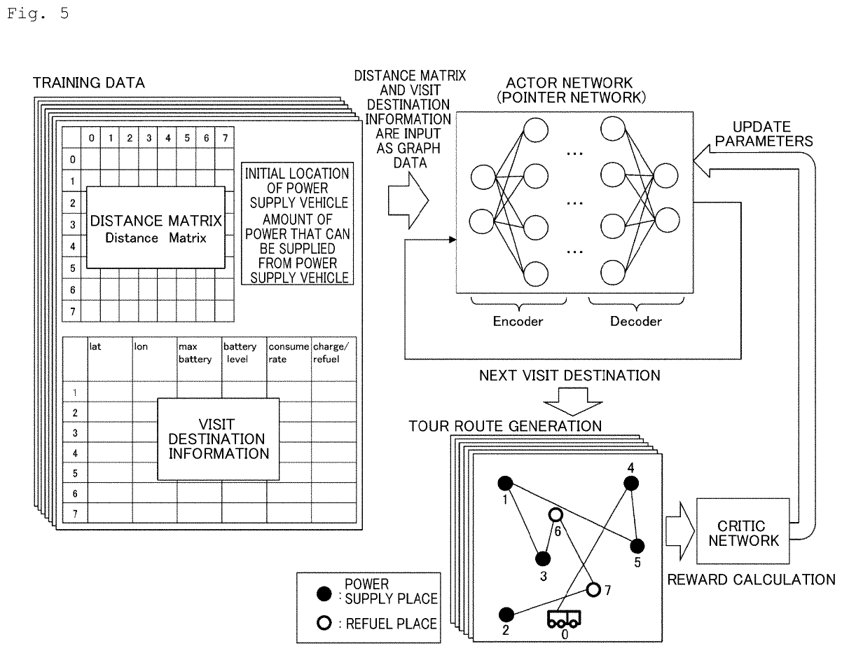

FIG. 5 schematically shows an example of the above-mentioned model training. As shown in FIG. 5, a tour route is generated from each piece of training data by a pointer network (actor network), and a reward is calculated from each tour route by a critic network. Then, parameters (parameters of the actor network and parameters of the critic network) are updated such that the reward is maximized.

Finally, the model training unit 202 stores the learned model parameters learned in step S102 described above in the model parameter storage unit 206 (step S103).

### <Tour Route Generation Processing>

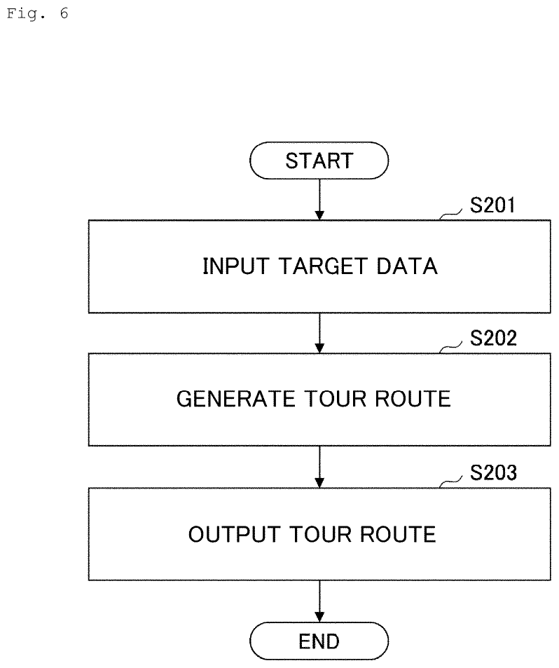

Hereinafter, tour route generation processing according to the present embodiment will be described with reference to FIG. 6. It is assumed that model parameters have been learned below.

First, the target data input unit 203 receives target data (step S201). Here, the target data includes initial locations of the actual number of power supply vehicles, an initial value of the actual amount of power that can be supplied from each of the power supply vehicles, a distance matrix representing distances on a map (travel distances on the map) when the actual initial locations of the power supply vehicles and respective visit destinations are regarded as nodes of a graph, and visit destination information representing various types of information of the visit destinations. When the time is calculated instead of the distance in procedure 6 in step S101 of FIG. 3, the distance matrix included in the target data also uses a matrix representing the travel time on the map.

Next, the tour route generation unit 204 generates a tour route according to a policy represented by a model in which learned model parameters stored in the model parameter storage unit 206 have been set using the target data input in the step S201 (step S202). For example, the tour route generation unit 204 generates a tour route by a pointer network in which the learned model parameters have been set using the target data. The method of generating a tour route is the same as step S102 in FIG. 3 except that the learned model parameters are used as model parameters of the pointer network.

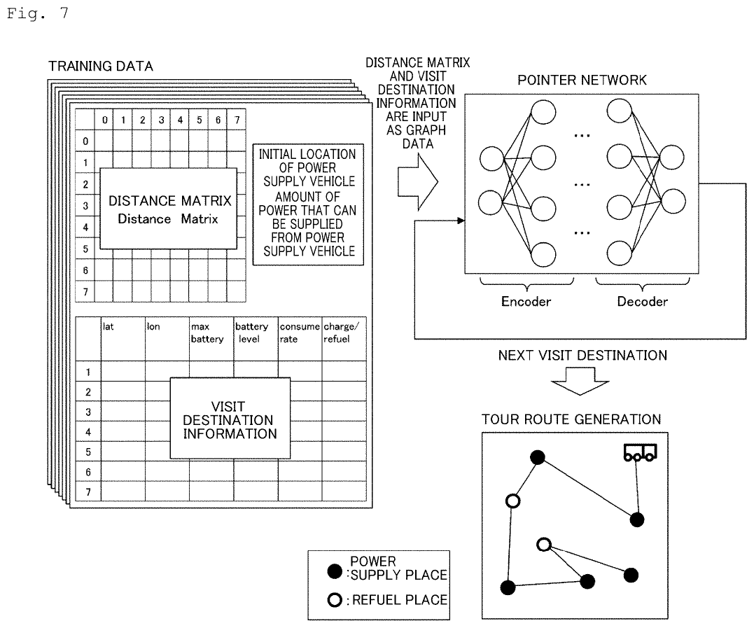

FIG. 7 schematically shows an example of the above-mentioned tour route generation. As shown in FIG. 7, a tour route is generated from the target data by the pointer network.

Finally, the output unit 205 outputs the tour route generated in step S202 to a predetermined output destination (step S203). Accordingly, a tour route having power supply places and refuel places as visit destinations can be obtained.

### MODIFIED EXAMPLE

Modified examples of the present invention will be described below.

### Modified Example 1

For example, working hour information of a driver who drives a power supply vehicle (information indicating predetermined working hours of the driver) is included in training data and target data, and the reward R may be calculated in consideration of working hours of the driver during training. Specifically, for example, the reward R may be calculated as follows.

$$R = {α}_{1} \times travel distance score + {α}_{2} \times storage battery depletion {score}^{} + {α}_{3} \times working hour score$$

Here, α₁, α₂, and α₃ are hyper parameters indicating which of a travel distance score, a storage battery depletion score, and a working hour score is to be regarded as important, and 0≤α₁, α₂, α3≤1 and α₁+α₂+α₃=1 are satisfied. The working hour score is a score which takes a lower value as a deviation between a driving time of a driver who drives a power supply vehicle and a predetermined threshold value (for example, predetermined working hours) is larger (or a score which takes a lower value as the driving time of the driver exceeds a predetermined threshold value (for example, predetermined working hours)).

Accordingly, for example, it is possible to prevent overworking or long-time labor in consideration of working hours of the driver of the power supply vehicle. Further, it is also possible to prevent an accident caused by fatigue of the driver due to long-time labor or the like.

### Modified Example 2

For example, stay time information of a refuel place (information indicating a minimum stay time (or a minimum refuel time) at the refuel place, an average stay time (or an average refuel time), a stay available time (or refuel available time), and the like) is included in training and target data, and the reward R may be calculated in consideration of a stay time of the power supply vehicle at the refuel place during training. Specifically, for example, the reward R may be calculated as follows.

$$R = {α}_{1} \times travel distance score + {α}_{2} \times storage battery depletion {score}^{} + {α}_{3} \times stay time score$$

Here, α₁, α₂, and α₃ are hyper parameters indicating which of a travel distance score, a storage battery depletion score, and a stay time score is to be regarded as important, and 0≤α₁, α₂, α₃≤1 and α₁+α₂+α₃=1 are satisfied. The stay time score is a score which takes a lower value as the sum of stay times of the power supply vehicle at refuel places (or refuel times at the refuel places) is larger.

Accordingly, for example, it is possible to reduce a time for staying at a refuel place (or a time required for refuel) in consideration of a congestion state or the in the refuel place.

### CONCLUSION

As described above, the tour route generation apparatus 10 according to the present embodiment can generate a tour route having not only demand places where resources such as energy, substances, and commodities supplied by a vehicle are demanded but also supply places where such resources are supplied (or replenished) to the vehicle as visit destinations. Therefore, by using the tour route generation apparatus 10 according to the present embodiment, it is possible to generate a high-accuracy tour route close to actual operation when a vehicle supplies resources to demand places.

The present invention is not limited to the above-described specifically disclosed embodiment, and various modifications and changes, combinations with known technique, and the like can be made without departing from the scope of the claims.

### REFERENCE SIGNS LIST

10 Tour route generation apparatus
101 Input device
102 Display device
103 External I/F
103a Recording medium
104 Communication I/F
105 RAM
106 ROM
107 Auxiliary storage device
108 Processor
109 Bus
201 Training data generation unit
202 Model training unit
203 Target data input unit
204 Tour route generation unit
205 Output unit
206 Model parameter storage unit

1. A tour route generation apparatus for generating a tour route of a moving body visiting demand places that require resources supplied by the moving body, and supply places that provide the resources to the moving body, the tour route generation apparatus comprising:
circuitry configured to:
generate training data for training a model that generates the tour route by using generation conditions that include (i) a first condition under which information on the demand places is generated, and (ii) a second condition under which information on the supply places is generated; and
learn a policy represented by the model through reinforcement learning using the training data.

2. The tour route generation apparatus according to claim 1,
wherein the first condition includes a range of a total number of the demand places, a range of maximum capacities of the resources at the demand places, and a range of consumption rates of the resources at the demand places, and
wherein the second condition includes a range of a total number of the supply places.

3. The tour route generation apparatus according to claim 2, wherein the circuitry is configured to:
randomly sample a number of demand places from the range of the total number of the demand places;
randomly sample a number of supply places from the range of the total number of the supply places;
randomly sample locations of the demand places from a predetermined geographical range, for each demand place;
randomly sample locations of the supply places from the geographical range, for each supply place;
randomly sample a maximum capacity value from the range of maximum capacities of the resources, for each demand place;
randomly sample a remaining resource amount value from a range of greater than or equal to zero and less than or equal to the maximum capacity value, for each demand place;
randomly sample a consumption rate value from the range of consumption rates of the resources at the demand places, for each demand place;
randomly sample an initial location of the moving body from the geographical range; and
generate, as the training data, data including
a matrix whose elements are travel distances or travel times between two locations among the locations of the demand places, the locations of the supply places, and the initial location of the moving body, and
destination information including a location of each of the demand places, the maximum capacity value, the remaining resource amount value, the consumption rate value, and a location of each of the supply places.

4. The tour route generation apparatus according to claim 3, wherein the model is a pointer network that includes:
an embedded layer and a graph convolution layer, as an encoder, and
an attention mechanism and a recurrent neural network cell, as a decoder,
wherein the pointer network is configured to output a location of a subsequent destination using, as input, graph data and a location of a destination in a previous step, and
wherein the matrix and the destination information are used as the graph data, and the initial location of the moving body is used as a location of a destination in an initial step.

5. The tour route generation apparatus according to claim 3, wherein the circuitry is configured to generate the tour route of the moving body according to the learned policy, by using target data including
a matrix whose elements are travel distances or travel times between two locations among actual locations of the demand places, actual locations of the supply places, and an actual initial location of the moving body, and
destination information including an actual location of each of the demand places, an actual maximum capacity value, an actual remaining resource amount value, an actual consumption rate value, and an actual location of each of the supply places.

6. A tour route generation method executed by a tour route generation apparatus for generating a tour route of a moving body visiting demand places that require resources supplied by the moving body, and supply places that provide the resources to the moving body, comprising:
generating training data for training a model that generates the tour route by using generation conditions that include (i) a condition under which information on the demand places is generated, and (ii) a condition under which information on the supply places is generated; and
learning a policy represented by the model through reinforcement learning using the training data.

7. A non-transitory computer readable storage medium storing a program configured to cause a computer to execute a method, the method comprising:
generating a tour route of a moving body visiting demand places that require resources supplied by the moving body, and supply places that provide the resources to the moving body;
generating training data for training a model that generates the tour route by using generation conditions that include (i) a condition under which information on the demand places is generated, and (ii) a condition under which information on the supply places is generated; and
learning a policy represented by the model through reinforcement learning using the training data.
